(19) United States
(12) Patent Application Publication
(10) Pub. No.: US 2010/0007915 A1
(43) Pub. Date: Jan. 14, 2010

(54) IMAGE SENDING APPARATUS

(75) Inventors: Kumiko OGINO, Osaka (JP); Takaya NAKATANI, Osaka (JP); Takeshi NAKAMURA, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/481,849

(22) Filed: Jun. 10, 2009

(30) Foreign Application Priority Data
Jul. 11, 2008 (JP) 2008-181515

(51) Int. Cl. G06F 15/00; G06F 17/21

(52) U.S. Cl. 358/1.15; 715/274

(57) ABSTRACT

Provided is an image sending apparatus capable of preventing that, in sending image data with additional information such as sending source information added thereto, the additional information is overlaid on a part other than a margin of the image data. The image sending apparatus is provided with an image display portion for displaying a preview of image data and is capable of sending the image data with additional information added thereto. The image sending apparatus is provided with a display control portion for displaying information showing an adding position at which the additional information is added to the image data subjected to a preview display on the image display portion in the preview display.

### CROSS-NOTING PARAGRAPH

This non-provisional application claims priority under U.S.C. §119 (a) on Patent Application No. 2008-181515 filed in JAPAN on Jul. 11, 2008, the entire contents of which are hereby incorporated herein by reference.

### FIELD OF THE INVENTION

The present invention relates to an image sending apparatus capable of displaying a preview of image data to be sent.

### BACKGROUND OF THE INVENTION

Conventionally, some image sending apparatuses such as facsimile apparatuses, internet facsimile apparatuses, and multi-functional peripherals provided with either one or both of the apparatuses have a function of displaying a preview of image data to be sent.

For example, Japanese Laid-Open Patent Publication No. 2001-313664 discloses an electronic mail and facsimile communication apparatus capable of displaying a preview of a facsimile sending image. Furthermore, Japanese Laid-Open Patent Publication No. 2003-87560 discloses an image forming apparatus that displays a finished image showing a state when post-processing is applied to paper on which an image is to be formed.

Meantime, in the case of performing facsimile sending or internet facsimile sending, the sending is performed in a state where additional information such as information of a sending source (transmission source) or information of date and time is added to a header or footer of image data to be sent.

However, when an adding position of such additional information is erroneously set or when the actually added information is overlaid on a part other than a margin of the image data to be sent, there is a problem that a part of the image data is unable to be read. Such a problem is unable to be solved by a technology of merely confirming the image data by a preview display on a display screen as shown in Japanese Laid-Open Patent Publications No. 2001-313664 and No. 2003-87560.

### SUMMARY OF THE INVENTION

An object of the present invention is to provide an image sending apparatus capable of, at the time of sending image data with additional information such as sending source information added thereto, preventing that an adding position of the additional information is erroneously set and that the additional information is overlaid on a part other than a margin of the image data.

Another object of the present invention is to provide an image sending apparatus that includes an image display portion for displaying a preview of image data and that is capable of sending the image data with additional information added thereto, wherein a display control portion for displaying information showing an adding position at which the additional information is added to the image data subjected to a preview display by the image display portion on the image display portion in the preview display is included.

Another object of the present invention is to provide the image sending apparatus, wherein the display control portion displays the information showing the adding position on the image display portion in a state where a preview of a whole of the image data is displayed on the image display portion.

Another object of the present invention is to provide the image sending apparatus, wherein the display control portion displays the additional information in a display area different from a display area of the information showing the adding position.

Another object of the present invention is to provide the image sending apparatus, wherein the display control portion displays the additional information at the adding position as the information showing the adding position.

Another object of the present invention is to provide the image sending apparatus, wherein the additional information includes any one of or a plurality of information of a name of a sender, information of a telephone number of a sending source, information of an electronic mail address of a sending source, and information of date and time in sending.

Another object of the present invention is to provide the image sending apparatus, wherein the display control portion displays a predetermined graphical user interface image for changing the adding position on the image display portion in response to a user operation, and the predetermined graphical user interface image includes any one of or a plurality of an image for selecting whether the adding position is at a header position or at a footer position, an image for shifting the adding position horizontally, an image for shifting the adding position vertically, and an image for changing a text size and/or a text font of the additional information.

Another object of the present invention is to provide the image sending apparatus, wherein the image sending apparatus has a function of sending the image data by facsimile and/or a function of sending the image data by internet facsimile.

### BRIEF DESCRIPTION OF THE DRAWINGS

FIG. 1 is a schematic diagram for showing an exemplary configuration of an image processing system constructed by using a digital multi-functional peripheral as an example of an image sending apparatus according to an embodiment of the present invention;

FIG. 2 is a schematic block diagram for showing an exemplary configuration of the digital multi-functional peripheral of FIG. 1;

FIG. 3 is an external view for showing an example of a touch panel and a key operation portion in the digital multi-functional peripheral of FIG. 2;

FIGS. 4A and 4B are diagrams for explaining an outline that a facsimile sending job is sent after displaying a preview thereof and confirming contents thereof in the digital multi-functional peripheral of FIGS. 2 and 3;

FIGS. 5A and 5B are diagrams for explaining an outline that position information of sending source information is displayed on image data to be sent that is displayed for previewing in the digital multi-functional peripheral of FIGS. 2 and 3;

FIGS. 6A and 6B are diagrams for explaining an outline that, while displaying position information of sending source information on image data to be sent that is displayed for previewing, an adding position thereof is adjusted in the digital multi-functional peripheral of FIGS. 2 and 3;

FIG. 7 is a diagram for explaining an outline that, when an adding position of sending source information is changed vertically and horizontally, position information of the sending source information is displayed again in the digital multi-functional peripheral of FIGS. 2 and 3;

FIG. 8 is a diagram for explaining an outline that a display color of additional information is adjusted in the digital multi-functional peripheral of FIGS. 2 and 3;

FIGS. 9A and 9B are diagrams for explaining an outline that, while displaying position information of sending source information on image data to be sent that is displayed for previewing, an adding position (display position) thereof is largely adjusted in the digital multi-functional peripheral of FIGS. 2 and 3;

FIGS. 10A and 10B are diagrams for explaining an outline that, while visually identifying image data to be sent that is displayed for previewing and position information of sending source information in a possibly larger area, an adding position thereof is adjusted in the digital multi-functional peripheral of FIGS. 2 and 3;

FIG. 11 is a flowchart for explaining an example of processing when displaying a preview in sending image data in the digital multi-functional peripheral of FIGS. 2 and 3;

FIGS. 12A and 12B are diagrams for explaining another example in which position information of sending source information is displayed on image data to be sent that is displayed for previewing in the digital multi-functional peripheral of FIGS. 2 and 3; and

FIGS. 13A and 13B are diagrams for explaining another example in which position information of sending source information is displayed on image data to be sent that is displayed for previewing in the digital multi-functional peripheral of FIGS. 2 and 3.

### PREFERRED EMBODIMENTS OF THE INVENTION

Now, a preferred embodiment of the present invention will hereinafter be described with reference to the drawings. An embodiment in which an image sending apparatus according to the present invention is applied to a digital multi-functional peripheral having a print function, a copy function, and a facsimile sending and receiving function, etc., will hereinafter be described specifically with reference to the drawings showing the embodiment.

### <Apparatus Configuration>

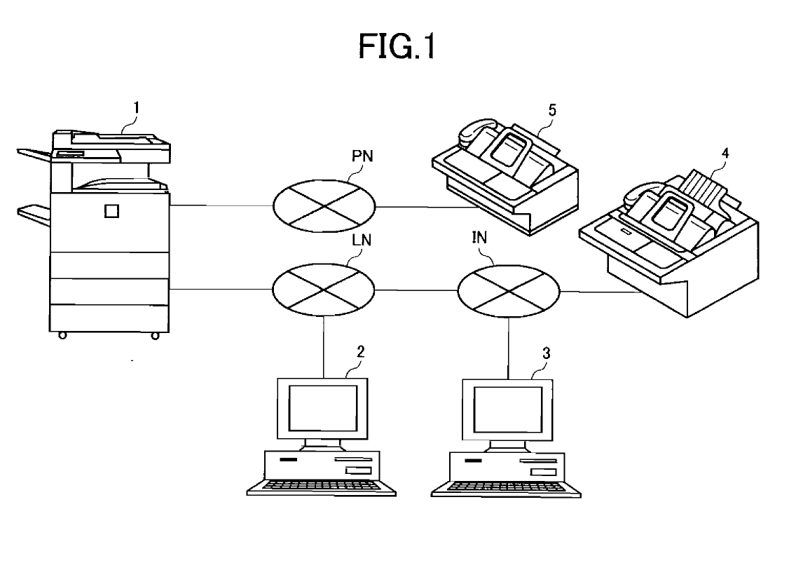

FIG. 1 is a schematic diagram for showing an exemplary configuration of an image processing system constructed by using a digital multi-functional peripheral as an example of an image sending apparatus according to an embodiment of the present invention. In FIG. 1, 1 denotes a digital multi-functional peripheral, 2 and 3 denote external computers, denotes an internet facsimile apparatus (internet FAX apparatus), and 5 denotes a facsimile apparatus.

The digital multi-functional peripheral 1 has a print function and a copy function, as well as a function of sending and receiving image data by facsimile (facsimile function) and/or a function of sending and receiving image data by internet FAX (internet FAX function). This digital multi-functional peripheral 1 is connected to various external devices through a communication network. For example, an external computer 2 such as a personal computer (PC) is connected to a communication network LN that is laid as a local communication network, and an external computer 3 and an internet FAX apparatus 4 are connected to an internet network IN that is connected through a gateway not shown in the figure, or the like. Further, an external facsimile apparatus 5 is connected through a public switched telephone network PN. Note that, as described above, although description will be given only for the case where the image sending apparatus according to the present invention is applied to the digital multi-functional peripheral 1, any of the external computers 2 and 3, the internet FAX apparatus 4, and the facsimile apparatus 5 is also applicable as the image sending apparatus according to the present invention.

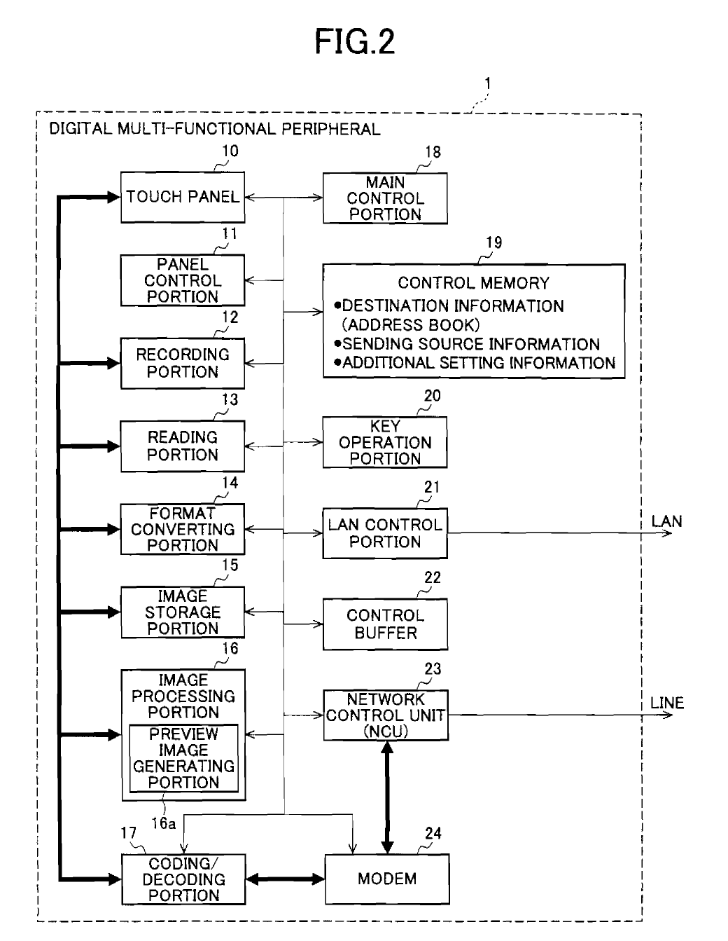

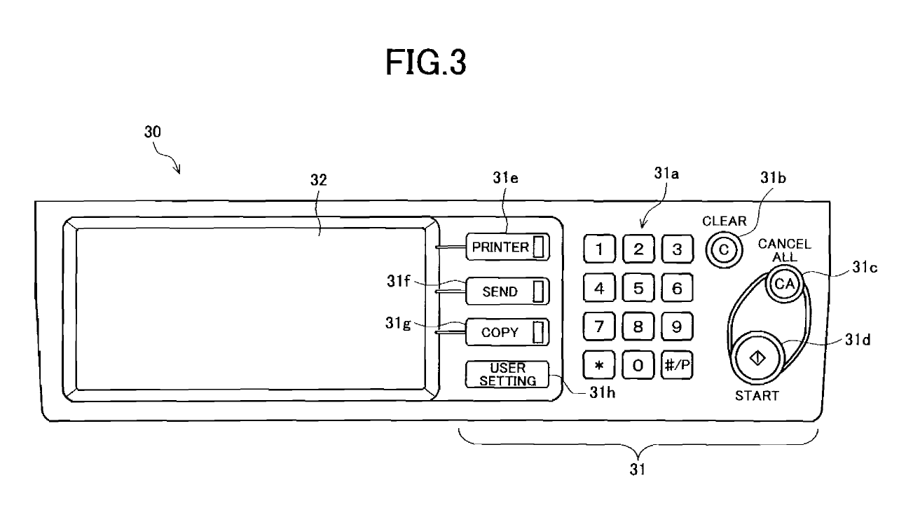

Description will be given for a configuration and an operation of the digital multi-functional peripheral 1. FIG. 2 is a schematic block diagram for showing an exemplary configuration of the digital multi-functional peripheral of FIG. 1, and FIG. 3 is an external view for showing an example of a touch panel and a key operation portion of the digital multi-functional peripheral of FIG. 2.

The digital multi-functional peripheral 1 illustrated in FIG. 2 is provided with a touch panel 10, a panel control portion 11, a recording portion 12, a reading portion 13, a format converting portion 14, an image storage portion 15, an image processing portion 16, a coding/decoding portion 17, a main control portion 18, a control memory 19, a key operation portion 20, a LAN (Local Area Network) control portion 21, a control buffer 22, a network control unit (NCU) 23, and a modem 24.

The main control portion 18 is comprised of a CPU (Central Processing Unit), a DSP (Digital Signal Processor), or the like. The control memory 19 is comprised of a nonvolatile memory or the like, such as a ROM (Read Only Memory) or an EEPROM (Electrically Erasable and Programmable ROM). A program (firmware) and various setting data are stored in the control memory 19 so as to be readable from the main control portion 18. Among them, at least the various setting data is stored in a rewritable memory. The program and the various setting data may be stored in hard disc as an exemplary configuration of the image storage portion 15, which will be described below. The control buffer 22 is comprised of a volatile memory such as a RAM (Random Access Memory).

The above-described program is used for the main control portion 18 to carry out a command concerning generation and display of a preview image, which will be described below, according to the present invention, as well as a command concerning generation/sending/reception, etc., of a facsimile image and an electronic mail, etc., a command concerning reading of an original, a command concerning printing, a command concerning reading and printing (that is, copying) of an original, and the like, with respect to other parts. This program is developed by the main control portion 18 on the control buffer 22 and is executed by referring to various setting data, which will be described below, appropriating the control buffer 22 as a data area for temporal storing (working) The reading portion 13 reads an original as a bitmap image of RGB (R: Red, G: Green, and B: Blue) with a predetermined resolution by a scanner using a CCD (Charge Coupled Device) and outputs the read RGB image data (dot image data) to the image processing portion 16. The image processing portion 16 is comprised of an ASIC (Application Specific Integrated Circuit) or the like, and applies various image processing to target image data. An example of the image processing will be described below. The ASIC may be incorporated with other parts such as the coding/decoding portion 17.

The image storage portion 15 is comprised of hard disc or the like, and stores image data that has been read by the reading portion 13 and has passed through the image processing portion 16, image data that has been received from outside through the LAN control portion 21, the NCU 23, etc., and the like. When image data is stored in the image storage portion 15, data that has been coded by the coding/decoding portion 17 may be also stored. Moreover, the image storage portion 15 may temporarily save intermediate data generated during image processing at the image processing portion 16.

The coding/decoding portion 17 compresses image data by coding and decodes (expands) the coded image data to original image data. For example, the coding/decoding portion 17 performs coding of image data read from an original, decoding of the coded data, decoding of coded image data received from outside, and the like. In the coding/decoding portion 17, coding systems corresponding to purposes are usable, including JPEG (Joint Photographic Experts Group) that is generally used in filing, and MH (Modified Huffman), MR (Modified READ) and MMR (Modified Modified READ) that are generally used in facsimile communication. As the coding system, MH is employable in IP facsimile communication, and MH, MR, and MMR as well as JPEG and JBIG (Joint Bi-level Image Experts Group) are employable in internet facsimile communication.

The format converting portion 14 converts read image data or image data received from outside into a predetermined file format such as a PDF (Portable Document Format), a GIF (Graphics Interchange Format), or a TIFF (Tag Image File Format).

The recording portion 12 is provided with a printer apparatus that employs a printing system such as an electrophotographic system or an inkjet system, and records (that is, prints) image data and the like stored in the image storage portion 15 on recording paper.

The modem 24 is comprised of a facsimile modem capable of facsimile communication, and is connected to a telephone line and is directly connected to the NCU 23. The NCU 23 is connected to the telephone line to control the line. That is, the NCU 23 is hardware that performs an operation of closing and opening the line with an analogue public switched telephone network (PSTN), and connects the modem 24 to the public switched telephone network as necessary. Such a configuration enables to send image data stored in the image storage portion 15 to outside by facsimile, to receive facsimile image data from the telephone line to store in the image storage portion 15, or to print by the recording portion 12 directly.

The LAN control portion 21 is connected to a LAN and performs communication of electronic mail data and communication of internet FAX via an internet. The internet FAX uses a LAN interface or the like to send and receive an electronic mail through a computer network such as a LAN.

The touch panel 10 or the key operation portion 20 receives an operation for selecting desired processing out of processing of reading an original, processing of sending and printing image data, etc., an operation for staring the processing, an operation for performing a setting that is necessary when each processing is executed (a selecting operation or an inputting operation), and the like. Various examples of the setting include a setting of the number of printed sheets in printing and a setting of destination information in sending a facsimile image or an electronic mail.

The key operation portion 20 is provided with a key group necessary for operations. The touch panel 10 has a display portion and an operation receiving portion such as a touch sensor. The touch panel 10 is subjected to display control and operation reception control by the panel control portion 11. That is, the panel control portion 11 performs the display control for the display portion and the operation reception control for the operation receiving portion in the touch panel 10.

On the display portion of the touch panel 10, a current operating state, setting information (for example, sending destination, etc.,) and the like are displayed. The display is realized when the panel control portion 11 performs control to display a GUI (Graphical User Interface) image. The GUI enables to change the display and an operation received position depending on a user operation. Each GUI and images thereof may be stored so as to be readable in an internal memory of the panel control portion 11 or the control memory 19. In addition, as the display portion, display devices in various display systems including liquid crystal displays and organic EL (Electroluminescence) displays are employable.

The user operation received on the touch panel 10 is interpreted by the panel control portion 11 and is transmitted as an operation signal to the main control portion 18. The user operation received by the key operation portion 20 is interpreted by the key operation portion 20 itself and transmitted as an operation signal to the main control portion 18. The main control portion 18 issues a command in accordance with the operation signal obtained in this manner to other parts to cause the other parts to execute processing in accordance with the user operation. Note that, although description has been given with reference to the touch panel 10 in which the display device and the operation portion are integrated, only the display apparatus may be simply provided instead of the touch panel 10 and, in that case, where the user operation is received only by the key operation portion 20.

The touch panel 10 and the key operation portion 20 may be configured as an operation panel 30 as illustrated in FIG. 3, and the operation panel 30 is comprised of a key operation portion 31 (corresponding to the key operation portion 20) provided with various hardware keys and a touch panel 32 (corresponding to the touch panel 10) comprised of a liquid crystal display and a touch sensor. The present invention will hereinafter be described in detail with the touch panel 32 and the key operation portion 31 applied in the configuration of FIG. 1 instead of the touch panel 10 and the key operation portion 20.

The key operation portion 31 is provided with, as hardware keys, a numeric keypad 31a for inputting numeric values, a clear key 31b for clearing input set values, a cancel all key 31c for canceling all of various input settings, and a start key 31d for receiving instructions of start of copying, start of sending, etc., as well as function switch keys 31e, 31f, and 31g for switching a print function, a sending function and a copy function, and a system setting key 31h for receiving a setting by a user.

An exemplary operation in the digital multi-functional peripheral 1 having the above-described exemplary configuration will be described.

### <Original Reading Operation>

An original reading operation is performed when image data of a read original is stored (filed) in the image storage portion 15, when image data of a read original is sent to outside, when image data of a read original is printed (that is, copied), and the like.

When a user operation to perform processing requiring original reading is received by the operation panel 30, the main control portion 18 gives an instruction to the reading portion 13, the image storage portion 15, the image processing portion 16, the coding/decoding portion 17, and the like to execute processing as will be described below.

The reading portion 13 optically reads an image of an original placed on a document platen or an automatic document feeder and provides the image processing portion 16 with RGB image data (bitmap data of RGB) as a result of reading. The image processing portion 16 executes various image processing (hereinafter, referred to as original image processing) such as A/D conversion, shading correction, and γ correction for the RGB image data. Here, the shading processing is processing to remove various distortions generated in an illumination system, an image focusing system, and an image sensing system of the reading portion 13.

As the original image processing, original determination processing and segmentation processing may be executed subsequently to the A/D conversion, the shading correction, and the γ correction. The original determination processing includes processing of determining a type of the original and processing of determining whether the original is a color original or a monochromatic original based on input image data (image data subjected to the γ correction in this case). Examples of the type of the original include a text original, a printed photograph original, and text and printed photograph original in combination thereof. The image processing portion 16 outputs a determination signal (hereinafter, referred to as original determination data) as a result of the original type determination processing and the monochromatic/color original determination processing. The segmentation processing is processing of determining to what kind of area each pixel of the input image data (image data subjected to the γ correction in this case) belongs, and an example thereof includes processing of determining to which area including a black text area, a color text area and a halftone area each pixel belongs. The image processing portion 16 outputs segmentation data as a result of the determination. Note that, the segmentation processing may be executed based on the result of the above-described original determination processing and monochromatic/color original determination processing.

The original determination data and the segmentation data are stored in the image storage portion 15 in association with corresponding image data (image data subjected to the original image processing). At this time, the original determination data and the segmentation data are coded by the coding/decoding portion 17 and each coded data is thereafter stored in the image storage portion 15 in association with the corresponding image data. Note that, although the coding in storing in the image storage portion 15 is not essential, description will be given assuming that the image data is stored in a state of being coded. This is also the same in operations other than the original reading operation.

### <Printing Operation>

By the above-described original reading operation, processing up to filing of the image data of the read original is completed. Next, description will be given for a printing operation when the image data of the read original is printed (that is, when the original is copied). When the user operation to perform processing requiring printing is received by the operation panel 30, the main control portion 18 gives an instruction to the recording portion 12, the image storage portion 15, the image processing portion 16, the coding/decoding portion 17, and the like to execute processing as will be described below. Note that, the main control portion 18 also gives an instruction to the reading portion 13 (original reading instruction), for example, when a copy operation is performed.

The coding/decoding portion 17 reads and decodes image data to be printed and original determination data and segmentation data corresponding thereto from the image storage portion 15, which are provided to the image processing portion 16. The image processing portion 16 executes various image processing (hereinafter, referred to as image processing for printing) for the decoded image data (RGB image data). As will be schematically described below, examples of the image processing for printing include image quality adjustment processing, two-color processing, color correction processing, black generation and under color removal processing, spatial filter processing, scaling processing, output tone correction processing, and halftone generation processing. The black generation and under color removal processing, the spatial filter processing, and the halftone generation processing are processing in accordance with various areas indicated by the segmentation data.

As the image quality adjustment processing, a background is detected from the decoded image data to perform background removal. Moreover, as the image quality adjustment processing, RGB adjustment (color adjustment; entire color adjustment of redness or blueness), brightness adjustment, and vividness adjustment are also performed for the image data subjected to the background removal based on setting information set by a user from the operation panel 30. At this time, adjustment in accordance with an original type indicated by the original determination data may be performed.

As the color correction processing, CMY data having components of CMY (C: Cyan, M: Magenta, Y: Yellow) which are complementary colors of RGB is generated from the RGB data subjected to the image quality adjustment processing and processing of enhancing color reproduction is performed. As the black generation and under color removal processing, black generation processing of generating black (K) data from the CMY data subjected to the color correction and under color removal processing of subtracting the K data obtained by the black generation from the original CMY data to generate new CMY data. As the spatial filter processing, enhancement processing or smoothing processing is performed for CMYK data which is data of the four colors. When a two-color mode for outputting the image data in two colors (for example, red and black) is selected, the two-color processing is performed. As the two-color processing, processing of converting the RGB data into CMY data that represents specified two colors (red and black in this case) is performed. In the case of the two-color mode, the black generation and under color removal processing is executed for the CMY data subjected to the two-color processing and the spatial filter processing is also executed, however, the color correction processing is not performed.

As the scaling processing, image enlarging processing or image reducing processing is performed for the CMYK data subjected to the spatial filter processing based on a printing copy ratio set by the user operation from the operation panel 30. The printing copy ratio is a copy ratio of a printed image for the image indicated by read and stored image data. Of course, the printing copy ratio is not limited to a copy ratio obtained by the user operation and is a copy ratio set as default when no operation is performed for the printing copy ratio. As the output tone correction processing, output γ correction processing of outputting to a recording medium such as recording paper is performed for the CMYK data. As the halftone generation processing, tone reproduction processing of outputting an image by error diffusion processing and dither processing is performed for the CMYK data subjected to the output tone correction processing. In the output tone correction processing and the halftone generation processing, processing in accordance with an original type indicated by the original determination data may be performed, for example, including differentiating processing contents between a text area and other areas.

The CMYK data subjected to the halftone generation processing is provided to the recording portion 12. The recoding portion 12 receives the image data to which the image processing for printing has been given by the image processing portion 16 in this manner (the CMYK image data in this example) and generates a hard copy (prints out) by an electrophotographic system or an inkjet system. Note that, the data targeted for the printing operation described here is not limited to the image data read by the reading portion 13, and, for example, image data (image file) that has been previously transferred from an external recoding medium, a PC connected through a network, or the like and stored in the image storage portion 15 is also applicable in the same manner. The printing operation for the image data that has been received by facsimile and stored in the image storage portion 15 will be described below.

### <Preview Display Operation for Image Data to be Printed>

Next, description will be given for an operation of displaying a preview of image data stored in the image storage portion 15 as a result of reading an original on the touch panel 32 before printing (preview display operation). The preview display operation is performed when the user operation to perform processing requiring the preview display is received by the operation panel 30. For example, the preview display operation is also performed, when a setting is made such that a preview of the image data after the original reading is displayed before executing printing. The main control portion 18 gives an instruction to the image storage portion 15, the image processing portion 16, the coding/decoding portion 17, the panel control portion 11, and the like to execute processing as will be described below. Note that, the main control portion 18 also gives an instruction to the reading portion 13 (original reading instruction), for example, when an operation of copying an original is performed.

The coding/decoding portion 17 reads and decodes image data to be displayed for previewing and original determination data and segmentation data corresponding thereto from the image storage portion 15, which is provided to the image processing portion 16. The image processing portion 16 executes various image processing (hereinafter, referred to as image processing for previewing) for the decoded image data (RGB image data). As will be schematically described below, examples of the image processing for previewing include image quality adjustment processing, two-color processing, color correction processing, spatial filter processing, scaling processing, and output tone correction processing. The spatial filter processing and the output tone correction processing are processing in accordance with various areas indicated by the segmentation data.

The image quality adjustment processing here is the same as the image quality adjustment processing in the image processing for printing. As the color correction processing, processing of converting the image data subjected to the image quality adjustment processing (RGB data) into R′G′B′ data based on display characteristics of the touch panel 32. As the spatial filter processing, enhancement processing or smoothing processing is performed for the R′G′B′ data.

As the scaling processing, image enlarging processing/image reducing processing in accordance with a printing copy ratio is applied to the R′G′B′ data subjected to the spatial filter processing, and processing of converting a pixel number of the R′G′B′ data into a pixel number (display resolution) of the touch panel 32 is performed and image enlarging processing or image reducing processing is performed based on a preview display magnification set by the user operation from the operation panel 30 at the same time. The preview display magnification is a fixed display magnification such as twice and four times, for example, and is a display magnification of an image in the preview display. Of course, the preview display magnification is not limited to a display magnification obtained by the user operation, and is a display magnification set as default when no operation is performed for the preview display magnification.

A preview image generating portion 16a provided in the image processing portion 16 generates an image for the preview display (preview image) mainly by such scaling processing for the preview display.

As the output tone correction processing, output γ correction processing of displaying image data on the touch panel 32 is performed for the R′G′B′ data of the preview image. In the output tone correction processing, processing in accordance with an original type indicated by the original determination data may be performed, for example, including differentiating processing contents between a text area and other areas.

The two-color processing is executed only when a two-color mode for outputting image data in two colors of red and black, for example, is selected. As the two-color processing, processing of converting the RGB data subjected to the image quality adjustment processing into CMY data that represents specified two colors (red and black in this case) is performed. The generated CMYK data is converted into R′G′B′ data based on display characteristics of the touch panel 32 at the subsequent color correction processing.

The R′G′B′ data generated by the preview image generating portion 16a and subjected to the output tone correction processing is provided to the touch panel 32. The panel control portion 11 performs control for the touch panel 32 to display an image corresponding to the R′G′B′ data in a state of being incorporated in a GUI image and displays the GUI image on the touch panel 32. Note that, the data targeted for the preview display operation described here is not limited to the image data read by the reading portion 13, and image data (image file) that has been previously transferred from an external recording medium, a PC connected through a network, or the like and stored in the image storage portion 15, for example, is also applicable in the same manner. The preview display operation for the image data that has been received by facsimile and stored in the image storage portion 15 will be described below.

### <Supplement for Original Reading, Preview Display and Printing>

Although description has been given for the preview display operation separately from the printing operation, the printing operation may be performed such that the image data (CMYK data) subjected to the output tone correction processing is converted into the R′G′B′ data based on display characteristics of the touch panel 32, is processed by conversion processing corresponding to a pixel number (display resolution) of the touch panel 32 and scaling processing corresponding to a reducing/enlarging ratio in the preview display, and is displayed on the touch panel 32. Since the printing operation is completed to a certain extent and the printing operation after the preview display is able to be completed quickly, it is useful in a case where a setting is made such that a preview is previously displayed, for example, when the copy operation is performed.

In addition, an example in which the coded image data, the original type data and the segmentation data are stored in the image storage portion 15 in association with one another has been taken as the original reading operation, based on which the printing operation and the preview display operation have been also described. As an alternative method thereof, coding may be performed only for the image data read by the reading portion 13, which is temporarily stored in the image storage portion 15. In this case, it may be configured such that the image processing portion 16 applies the original type determination processing and the segmentation processing for the image data that has been read from the image storage portion 15 and decoded by the coding/decoding portion 17 in the printing operation and the preview display operation. In addition, such an alternative method is also applicable in sending image data such as sending by facsimile or sending by internet FAX, which will be described below.

### <Printing Operation for Image Data Received by Facsimile>

Next, description will be given for the printing operation for image data received by facsimile communication. When detecting a facsimile communication request by the modem 24, the main control portion 18 gives an instruction to the recording portion 12, the image storage portion 15, the image processing portion 16, the NCU 23, the modem 24, and the like to execute processing as will be described below.

First, the modem 24 and the NCU 23 sequentially receive image data (compressed image data) sent from a sending source while performing communication procedure and expands the received compressed image data, and executes rotating processing (processing of rotating a sending direction), resolution conversion processing, and the like as necessary to provide to the image processing portion 16 at the same time.

Since the image data received by facsimile communication is black-and-white binary data, particular processing is not performed for the image data (K data) to which processing such as expansion has been given in the image processing portion 16, which is directly provided to the recording portion 12. The recording portion 12 receives the image data and executes printing by an electrophotographic system, an inkjet system, or the like.

Description has been given for the facsimile reception of the monochromatic image, but when a color facsimile image (RGB data) is received, the image processing portion 16 may execute the image processing for facsimile reception described here for the RGB data.

### <Preview Display Operation for Image Data Received by Facsimile>

The preview display operation for image data received by facsimile communication will be briefly described based on the printing operation for the same image data. The preview display operation is performed, for example, when a previous setting or a user operation to execute printing after confirming the received image data in advance is performed. In the preview display operation, the image processing portion 16 performs the conversion processing in accordance with a pixel number (display resolution) of the touch panel 32 and scaling processing in accordance with a reducing/enlarging ratio in the preview display for the image data to which processing such as expansion has been given and the image data subjected to the scaling processing is displayed on the touch panel 32. A user is able to confirm the image displayed for previewing and determines whether to execute or cancel printing to perform a printing or cancelling operation.

### <Facsimile Sending Operation>

Next, description will be given for a sending operation when image data of a read original is sent by facsimile. The facsimile image data is sent to destination (sending destination) information set by the user operation from the touch panel 32 or the key operation portion 31. The destination information (telephone number in this example) is stored in the control memory 19 and is read as necessary. The destination information is generally stored as address book data so that information of a plurality of destinations is viewable and selectable, or is directly input before sending.

When the user operation to execute the facsimile sending is received by the operation panel 30, the main control portion 18 gives an instruction to the image storage portion 15, the image processing portion 16, the coding/decoding portion 17, the NCU 23, the modem 24, and the like to execute processing as will be described below. Note that, the main control portion 18 also gives an instruction to the reading portion 13 (original reading instruction), for example, when the operation to send the original by facsimile is performed. Note that, it is also possible to select image data to be sent and start sending the image data by facsimile while displaying a preview of the image data stored in the image storage portion 15.

The coding/decoding portion 17 reads and decodes image data to be printed, and original determination data and segmentation data corresponding thereto from the image storage portion 15, which is provided to the image processing portion 16. The image processing portion 16 executes various image processing (hereinafter, referred to as image processing for facsimile sending) for the decoded image data (RGB image data). As will be schematically described below, examples of the image processing for facsimile sending include image quality adjustment processing, spatial filter processing, scaling processing, output tone correction processing, and halftone generation processing. The spatial filter processing and the halftone generation processing may be processing in accordance with various areas indicated by the segmentation data, where the segmentation data may not be used. Further, in the original reading operation following the facsimile sending, the segmentation processing for the read image data and coding and storage of the segmentation data may not be executed.

As the image quality adjustment processing, the decoded image data is converted into K data using a matrix coefficient. In this case, a matrix coefficient in accordance with an original type indicated by the original determination data may be used. As the spatial filter processing, enhancement processing or smoothing processing is performed for the K data. As the scaling processing, image enlarging processing and image reducing processing in accordance with a sending resolution set by the operation panel 30 or a sending resolution set as default are performed for the K data subjected to the spatial filter processing. As the output tone correction processing, output y correction processing intended to output to a recording medium such as recording paper at a sending destination, for example, is performed for the K data subjected to the scaling processing. Actually, not output γ correction processing for a device of the sending destination but output γ correction processing for a general device may be performed. As the halftone generation processing, binarization by error diffusion processing, for example, is performed for the K data subjected to the output tone correction processing. In the output tone correction processing and the halftone generation processing, processing in accordance with an original type indicated by the original determination data may be performed.

Description has been given for the facsimile sending of the monochromatic image, but when a color image is sent by facsimile, the image processing portion 16 may perform processing of converting the decoded image data into L*a*b* data for color transmission using a matrix coefficient as the image quality adjustment processing in the above-described image processing for facsimile sending so that the subsequent processing is performed for the L*a*b* data.

The image data subjected to the halftone generation processing is processed by rotating processing as necessary and is compressed and coded by the coding/decoding portion 17 with a compression format for the facsimile sending to be temporarily stored in the image storage portion 15. The modem 24 performs sending procedure to a sending destination set through the NCU 23, and at the time when communication with the sending destination is established (at the time ready for sending), the temporarily stored and coded K data is read and sequentially sent to the sending destination through the public network after necessary processing such as changing of the compression format.

The digital multi-functional peripheral 1 of the present invention is capable of sending image data to be sent with additional information such as sending source information (transmission source information) added thereto. The additional information added to the image data is an additional image. The additional information may be stored in the control memory 19. In addition, a plurality of additional information may be stored in the control memory 19 and additional setting information may be stored in the control memory 19. The additional setting information at least includes information showing a position to add to the image data to be sent (hereinafter, referred to as an adding position), and when a plurality of additional information is stored, information for selecting from among them is also included.

In the case of the facsimile sending with additional information added, synthesizing processing may be performed as follows. The main control portion 18 reads additional information and information showing an adding position, which is converted into image data by the main control portion 18 or the image processing portion 16, and the image processing portion 16 synthesizes the converted image data (image data of additional information) at the above-described adding position in image data of the adding destination which is image data subjected to the scaling processing. In the digital multi-functional peripheral 1 of the present invention, the position at which the image data of the additional information is added to the image data subjected to the scaling processing is defined as being settable by a user from the operation panel 30 while performing the preview display as will be described below. The synthesized image data is processed by the above-described output tone correction processing, rotating processing, and compression processing, etc., and thereafter sent to the sending destination.

### <Preview Display Operation for Image Data to be Sent by Facsimile>

It is essential that the digital multi-functional peripheral 1 of the present invention has a configuration allowing image data to be sent by facsimile sending or the like to be displayed for previewing. The preview display operation is performed, for example, when the previous setting or the user operation to execute sending after confirming the image data before sending in advance is performed. Description will be given for the preview display operation for the image data to be sent by facsimile based on the facsimile sending operation for the same image data. In the preview display operation, the main control portion 18 also gives an instruction to the panel control portion 11.

In the preview display operation, the image processing portion 16 may perform the same processing as in the facsimile sending up to the image quality adjustment processing, the spatial filter processing, and the scaling processing, and the preview image generation processing may be executed by the preview image generating portion 16a and the output γ correction processing for displaying the image data may be performed as the output tone correction processing. As the preview image generation processing, the preview image generating portion 16a performs conversion processing in accordance with a pixel number (display resolution) of the touch panel 32 and scaling processing in accordance with a reducing/enlarging ratio in the preview display for image data subjected to the image enlarging processing and the image reducing processing in accordance with a sending resolution to thereby generate data of the preview image. Note that, in the preview display operation, the spatial filter processing may not be executed and the halftone generation processing is not executed.

R′G′B′ data generated by the preview image generating portion 16a and subjected to the output tone correction processing is provided to the touch panel 32. The panel control portion 11 performs control for the touch panel 32 to display an image corresponding to the R′G′B′ data in a state of being incorporated in a GUI image to display the GUI image on the touch panel 32.

Further, in the digital multi-functional peripheral 1 of the present invention, the panel control portion 11 controls to display information showing a position at which additional information is added to the image data displayed for previewing (adding position) on the touch panel 32 in the preview display. Thus, the preview image generating portion 16a synthesizes the information showing the adding position with the preview image of the image data to be sent to generate a preview image with the adding position.

Specifically, when the image data to be sent and the information showing the adding position are displayed for previewing at the same time, the synthesizing processing may be performed as follows. The main control portion 18 reads information showing the adding position of the additional information to be added among additional setting information from the control memory 19, which is converted into image data capable of representing an area of the adding position shown by the information by the main control portion 18 or the preview image generating portion 16a, and the preview image generating portion 16a may synthesize the converted image data (image data showing the area of the adding position) at the above-described adding position in image data of the adding destination which is image data subjected to the scaling processing. The synthesized image data is processed by the above-described output tone correction processing (output γ correction processing for displaying image data) in the above-described preview display and thereafter is incorporated in a GUI image by the panel control portion 11 to be displayed on the touch panel 32.

As the information showing the adding position, the image itself of the additional information may be synthesized at the adding position to display a preview of the synthesized preview image with the additional information. In the case of the preview display with the additional information added, the main control portion 18 may read the information showing the adding position as well as the additional information itself from the control memory 19, the main control portion 18 or the preview image generating portion 16a may convert the additional information into image data, and the preview image generating portion 16a may synthesize the converted image data (image data showing the additional information) at the above-described adding position in image data of the adding destination which is image data subjected to the scaling processing. The synthesized image data is processed by the above-described output tone correction processing (output γ correction processing for displaying image data) in the preview display and thereafter is incorporated in a GUI image by the panel control portion 11 to be displayed on the touch panel 32.

Although description has been given for the preview display operation separately from the facsimile sending operation, the processing procedure as follows is also employable when the preview display is performed in a state where the image itself of the additional information is added at the adding position as the information showing the adding position. First, the image processing portion 16 converts the image data to which the output tone correction processing has been given (K data or L*a*b* data with the additional information synthesized) into R′G′B′ data based on display characteristics of the touch panel 32 as the facsimile sending operation, and performs conversion processing in accordance with a pixel number (display resolution) of the touch panel 32 and scaling processing in accordance with a reducing/enlarging ratio in the preview display, which is provided to the touch panel 32. The panel control portion 11 performs control for the touch panel 32 to display an image corresponding to the R′G′B′ data in a state of being incorporated in a GUI image and displays the GUI image on the touch panel 32.

### <Sending Operation for Image Data Via Internet>

Next, description will be given for a sending operation when image data of a read original is sent by an electronic mail or internet FAX via the internet. Such image data to be sent via the internet is also sent to sending destination information (electronic mail address in this example) set by the user operation from the touch panel 32 or the key operation portion 31 and stored in the control memory 19.

When the user operation concerning the sending via the internet is received by the operation panel 30, the main control portion 18 gives an instruction to the format converting portion 14, the image storage portion 15, the image processing portion 16, the coding/decoding portion 17, the LAN control portion 21, and the like to execute sending processing via the internet as will be described below. Note that, the main control portion 18 also gives an instruction to the reading portion 13 (original reading instruction), for example, when an operation to send an original via the internet is performed.

The coding/decoding portion 17 reads and decodes image data to be printed and original determination data and segmentation data corresponding thereto from the image storage portion 15, which is provided to the image processing portion 16. The image processing portion 16 executes various image processing (hereinafter, referred to as image processing for internet sending) for the decoded image data (RGB image data). Examples of the image processing for internet sending include the image quality adjustment processing, the spatial filter processing, the scaling processing, the output tone correction processing, and the halftone generation processing, which have been described in the image processing for facsimile sending.

Moreover, the image processing in the case of color image sending is also the same as the image processing for facsimile sending, and in the image processing for internet sending, the image processing portion 16 may perform processing of converting the decoded image data into L*a*b* data for color transmission using a matrix coefficient as the image quality adjustment processing so that the subsequent processing is performed for the L*a*b* data.

The coding/decoding portion 17 codes (compresses) the image data subjected to the image processing for internet sending to obtain compressed files. The compression is performed in the unit of a single page of the original. Subsequently, the format converting portion 14 converts the compressed files into a single file and the file is attached to a multipart mail according to MIME (Multipurpose Internet Mail Extension), for example. By the processing so far, the read image data is converted into a format of an electronic mail. The electronic mail is sent to a sending destination via the internet using a mail transfer protocol such as an SMTP (Simple Mail Transfer Protocol) through a LAN interface by the LAN control portion 21.

In the case of the internet facsimile sending, the coding/decoding portion 17 may perform the compression in a compression format only for facsimile such as MH, for example, and the format converting portion 14 may convert the obtained compressed files in the unit of a page, for example, into a single TIFF file. In the case of sending just by attaching to the electronic mail as an attached file (in the case of sending by so-called scan to e-mail), the coding/decoding portion 17 may perform the compression in a compression format such as JPEG, for example, and the format converting portion 14 may convert the obtained compressed files in the unit of a page into a single PDF file, for example.

In addition, even when image data to be sent is image data sent via the internet, the digital multi-functional peripheral 1 of the present invention is capable of sending the image data with additional information added thereto in the same manner as the case of the facsimile sending image data. As the additional information adding processing, the synthesizing processing described in the facsimile sending may be executed, and the image data is subjected to the output tone correction processing, the compression processing, the format conversion processing, and the like described above and thereafter sent to an address of a sending destination as an electronic mail.

### <Preview Display Operation for Image Data to be Sent Via Internet>

As well as mentioned in the description for the preview display in the facsimile sending, the digital multi-functional peripheral 1 of the present invention is capable of being configured so that a preview of image data to be sent via the internet is also able to be displayed on the touch panel 32.

In the preview display operation, as well as mentioned in the description for the preview display in the facsimile sending, the image processing portion 16 may perform the same processing as in the image processing for internet sending up to the image quality adjustment processing, the spatial filter processing, and the scaling processing, and the preview image generation processing may be executed by the preview image generating portion 16a, and the output γ correction processing for displaying the image data may be performed as the output tone correction processing. R′G′B data generated by the preview image generating portion 16a and subjected to the output tone correction processing is provided to the touch panel 32 and is displayed on the touch panel 32 in a state of being incorporated in a GUI image by the panel control portion 11. The description for the preview display in the facsimile sending may be also quoted for synthesizing of information showing an adding position or additional information.

### <Description for Preview Display Before Sending Image Data According to the Present Invention>

As has been described for the preview display operation in the facsimile sending and in the image data sending via the internet, the digital multi-functional peripheral 1 according to the present invention has the preview image generating portion 16a that reads at least image data to be sent from the image storage portion 15 and generates a preview image thereof. The preview image generated by the preview image generating portion 16a is sent to the touch panel 32 by the control from the main control portion 18, controlled to be displayed in a state of being incorporated in a GUI image by the panel control portion 11, and displayed on the touch panel 32. In this manner, the touch panel 32 is an example of an image display portion that displays a preview of the image data to be sent.

Further, as described above, in the digital multi-functional peripheral 1 of the present invention, the panel control portion 11 performs control for the image data displayed for previewing to display information showing an adding position of additional information on the touch panel 32 in the preview display based on the control from the main control portion 18. Thus, the preview image generating portion 16a generates the preview image from the information showing the adding position and the image data to be sent. In this manner, the preview image generating portion 16a and the panel control portion 11 are one example of a display control portion that performs control for the image display portion to display the information showing the adding position in the preview display. In addition, as described above, an image itself of the additional information may be synthesized at the adding position as the information showing the adding position to display a preview of the synthesized preview image with the additional information.

In this case, the additional information preferably includes any one of or a plurality of sending source information including information of a name of a sender, information of a telephone number of a sending source, and information of an electronic mail address of a sending source. Moreover, the additional information may include information of date and time in sending or may include sending source information together. It is also possible to include other additional information such as information of a destination.

A user is able to confirm an image displayed for previewing that includes the information showing the adding position (or additional information) and determine whether to directly execute or stop the facsimile sending or whether to execute changing of the adding position (or changing of the additional information) to perform an operation corresponding thereto.

In this manner, in the present invention, it is possible, when a preview of the image data to be sent is displayed on the display screen, to display information of an adding position at which additional information such as sending source information is added. This makes it possible to send the sending image data having the information added thereto after accurately confirming contents thereof and to prevent sending setting errors by a user. In particular, it is possible, when sending image data with additional information such as sending source information added thereto, to prevent that the adding position of the additional information is erroneously set and the additional information is overlaid on a part other than a margin of the image data.

### <Specific Example of Preview Display>

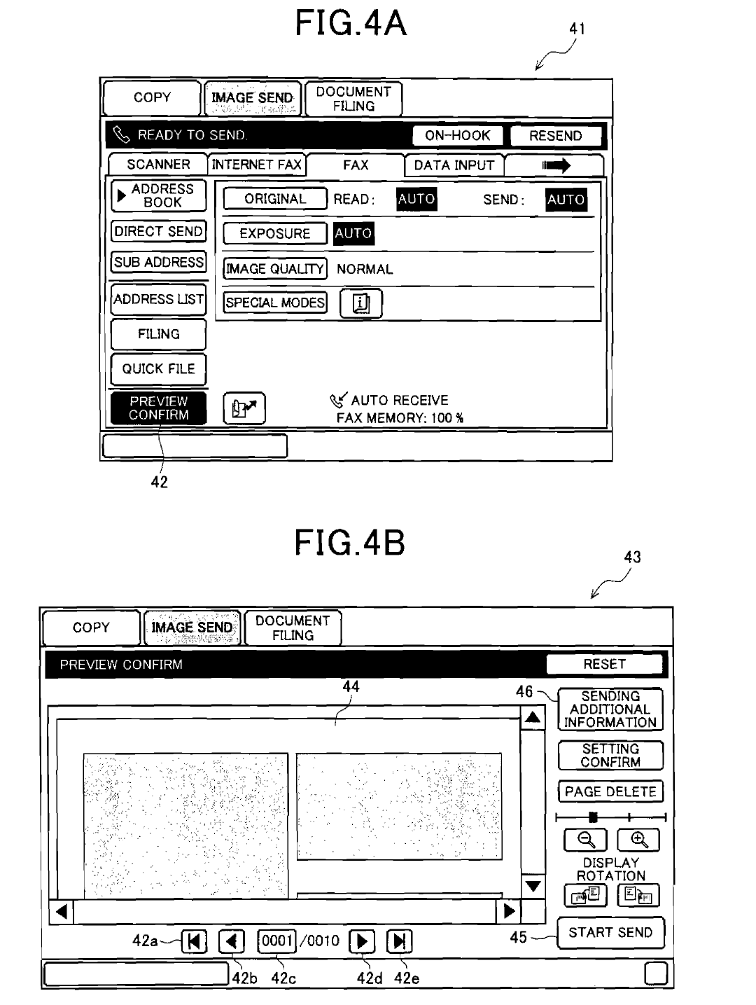

Referring to FIGS. 4A to 13B, description will hereinafter be given for information showing a position of additional information that is added to image data to be sent and for the flow of a preview display thereof, with specific examples. Although the facsimile sending will be taken as an example in the following example, this is the same as in the internet FAX and the like as described above.

FIGS. 4A and 4B are diagrams for explaining an outline that a facsimile sending job is sent after displaying a preview thereof and confirming contents thereof in the digital multi-functional peripheral of FIGS. 2 and 3. FIG. 4A shows an example of a GUI image displayed on the touch panel 32 (referred to as a GUI image 41) when a user selects facsimile sending out of image send. A preview confirm (image check) key 42 is displayed in the GUI image 41.

FIG. 4B shows an example of a GUI image shifted from the GUI image 41 and displayed on the touch panel 32 (referred to as a GUI image 43) when a user presses to select a selection area of the preview confirm key 42. As illustrated in the GUI image 43, a preview image 44 in which image data to be sent included in a facsimile sending job is reduced is generated by the preview image generating portion 16a to be displayed. Moreover, a preview confirmation screen shown by the GUI image 43 may be displayed prior to sending by pressing the preview confirm key 42 in the GUI image 41 to turn on and then pressing a start key 31d.

In the GUI image 43, a send start key 45 for staring sending and a sending additional information key 46 for displaying an adding position of additional information to be added for previewing in sending are displayed. This makes it possible for the user to select whether to send after confirming the position of the additional information or to directly send without confirming. Moreover, in the GUI image 43, a top page shift key 42a for displaying a first page, a previous page shift key 42b for displaying a page before a current page, information showing a current page 42c, a next page shift key 42d for displaying a page next to a current page, and a last page shift key 42e for displaying a last page are displayed to change pages of image data displayed for previewing.

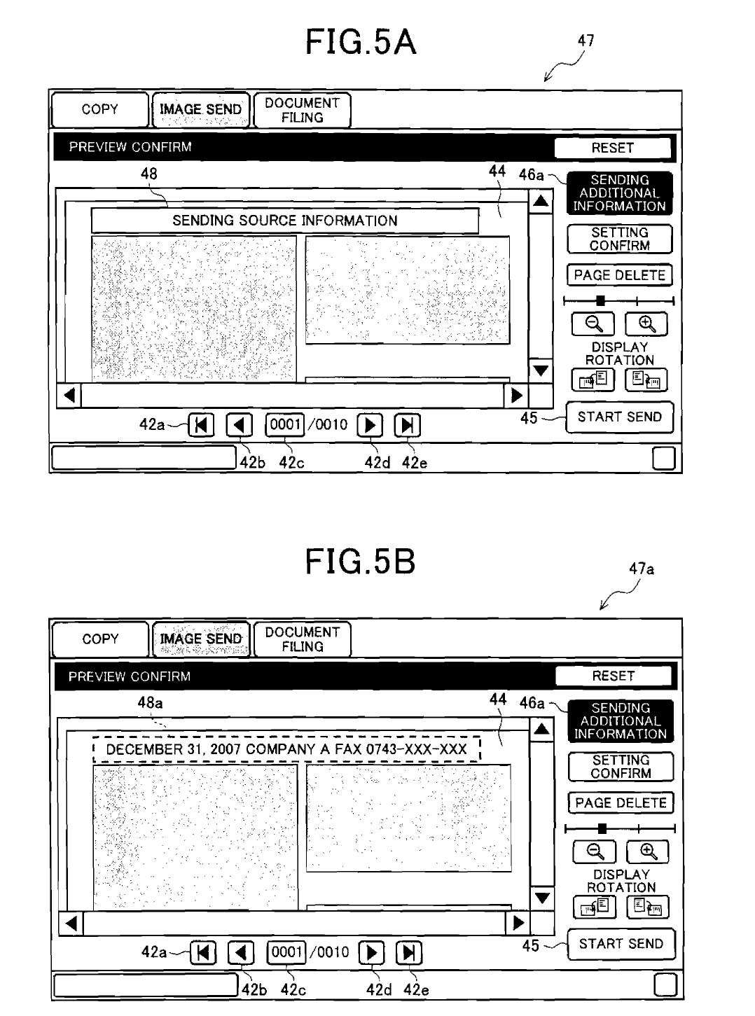

FIGS. 5A and 5B are diagrams for explaining an outline that position information of sending source information is displayed on image data to be sent that is displayed for previewing in the digital multi-functional peripheral of FIGS. 2 and 3. FIG. 5A shows an example of a GUI image displayed on the touch panel 32 (referred to as a GUI image 47) when a selection area of the sending additional information key 46 is pressed to selected in the GUI image 43 of FIG. 4B. As indicated by a sending additional information key 46a, the sending additional information key 46 is reversed by pressing. In the GUI image 47 shown in FIG. 5A, a display area 48 of sending source information is displayed in a state of being overlaid on the preview image 44 as information showing a position of the sending source information. Even when a preview image is changed due to horizontal and vertical shift or enlargement/reduction, the display area 48 is displayed at a position corresponding to the changed preview image. The display area 48 is also displayed in a preview image of a page displayed by each of page shift keys 42a, 42b, 42d, and 42e as long as it is set such that sending source information is displayed in that page. As in this example, just by indicating the position (relative position to the preview image 44) without indicating contents of additional information to be actually added, the user is able to determine whether or not sending is to be performed directly. If it is determined that sending may be to be performed directly, a selection area of the send start key 45 may be pressed.

However, it is preferable that the additional information to be actually added is displayed, and a GUI image 47a of FIG. 5B, which is shifted from the GUI image 43, shows such an example that the additional information is displayed. In the GUI image 47a, actual sending source information 48a is displayed at an adding position. In this manner, the preview image generating portion 16a and the panel control portion 11 preferably display the additional information itself at the adding position (synthesize with image data to be displayed for previewing so as to be displayed at the adding position) as information showing the adding position. Even when a preview image is changed due to horizontal and vertical shift or enlargement/reduction, the sending source information 48a is displayed at a position corresponding to the changed preview image, and is also displayed in a preview image of a page displayed by each of the page shift keys 42a, 42b, 42d, and 42e as long as it is set such that sending source information is displayed in that page (which is the same as in an example described below with reference to other drawings). By displaying the sending source information itself in this manner, the user is able to determine more accurately whether sending is to be performed directly. Although date and time, a sender, and a FAX number are displayed as the sending source information 48a in this example, an electronic mail address may be displayed instead of the FAX number, for example, in the case of sending by internet FAX or an electronic mail.

Description has been given assuming the case where sending source information is added to a sending job, but in the case of not being added, an image for inquiring whether or not to add, an image for setting contents to be added, an image for notifying that addition is impossible, or the like may be displayed without outputting the GUI image 47 or the GUI image 47a. It is found that there is no additional information even when there is no action in a view from the user.

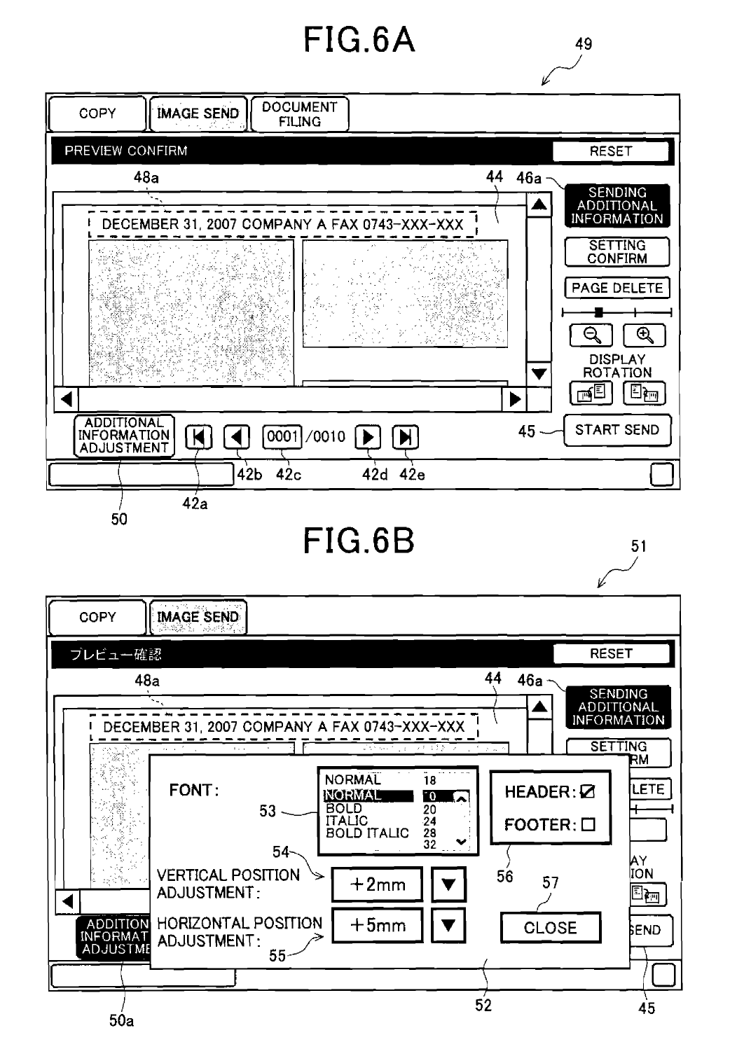

FIGS. 6A and 6B are diagrams for explaining an outline that, while displaying position information of sending source information on image data to be sent that is displayed for previewing, an adding position thereof (display position) is adjusted in the digital multi-functional peripheral of FIGS. 2 and 3.

FIG. 6A shows, instead of FIG. 5B, an example of a GUI image enabling to adjust an adding position of additional information that is shifted from the GUI image 43 and displayed (referred to as a GUI image 49). An additional information adjustment key 50 is displayed in the GUI image 49, and when a user presses a selection area thereof to select, a popup image 52 for adjusting a position of additional information (sending source information in this example) is displayed as shown in a GUI image 51 of FIG. 6B.

In the popup image 52, a font adjustment area 53 for adjusting a font type and size of text, a vertical position adjustment area 54 for adjusting a vertical position, a horizontal position adjustment area 55 for adjusting a horizontal position, a header/footer selection area 56 for selecting whether to add in a header or in a footer, and a close key 57 are displayed so as to be selectable. A selection area of the close key 57 may be pressed when completing a setting. The digital multi-functional peripheral 1 may be configured so that adjustment by other areas 53 to 56, which will be described below, is possible only alone or in combination of two or more kinds. That is, like the popup image 52, a GUI image that enables to perform all of the adjustments at once by a single user operation (operation of pressing the additional information adjustment key 50) may be displayed or a GUI image that enables to perform a plurality of adjustments out of all of the adjustments at once by a single user operation may be displayed. Further, a GUI image may be prepared for each adjustment to display a GUI image corresponding to each adjustment by another user operation.

In this manner, the panel control portion 11 preferably controls to display a GUI image for changing an adding position on the touch panel 32 in response to a first user operation illustrated by selection of the additional information adjustment key 50. When the main control portion 18 updates additional setting information in the control memory 19 upon the first user operation, it is possible to synthesize by referring to the additional setting information in sending.

In this manner, when it is configured so as to enable that information of an adding position is confirmed by a preview to change a position, it is possible to prevent or correct an erroneous setting by a user. Moreover, by enabling to adjust a position of sending source information using the popup image 52, it is possible to display the preview image 44 and the sending source information 48a, and the adjustment area in parallel, thus making it possible to perform position adjustment more easily compared to the case of not being popup.

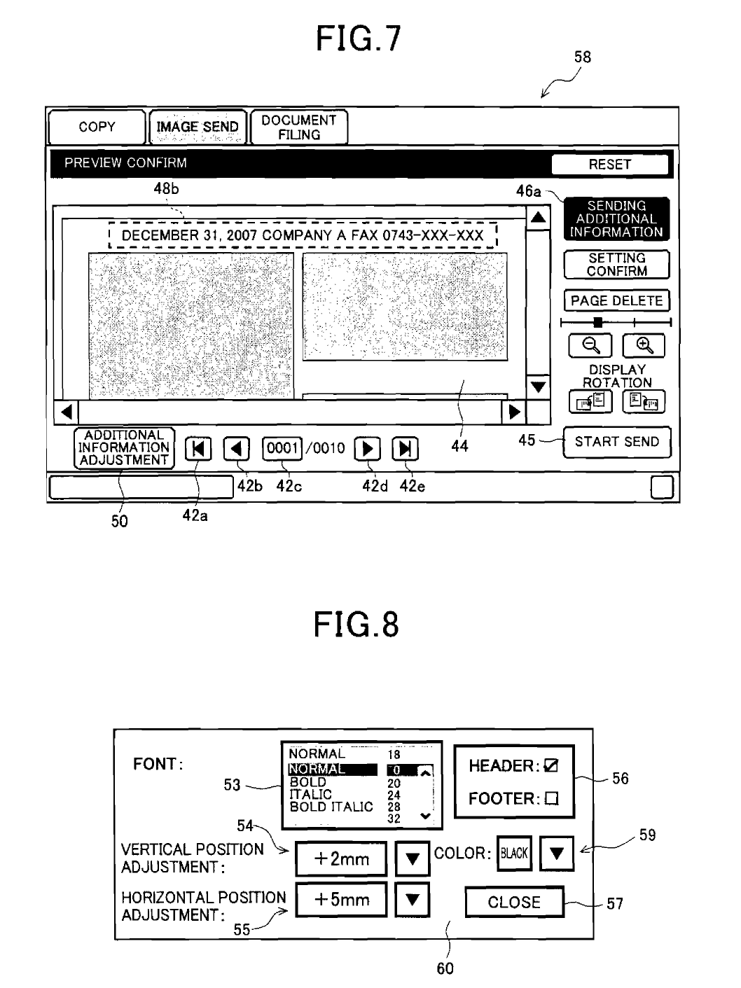

FIG. 7 is a diagram for explaining an outline that, when an adding position of sending source information is changed vertically and horizontally, position information of the sending source information is displayed again in the digital multi-functional peripheral of FIGS. 2 and 3. FIG. 7 shows an example of a GUI image (referred to as a GUI image 58) when a vertical position is changed by only +2 mm (2 mm upward) in the vertical position adjustment area 54 and a horizontal position is changed by only +5 mm (5 mm to the right) in the horizontal position adjustment area 55 in the popup image 52 in the GUI image 51 of FIG. 6B. It is found that the sending source information 48b in the GUI image 58 is displayed at the upper right from the sending source information 48a in the GUI images 49 and 51. In this manner, the position of the sending source information is shifted not only in the actual setting (additional setting information) but also on the screen in association with a numeric value of vertical/horizontal position adjustment.

In this manner, the panel control portion 11 preferably controls to display a GUI image for shifting the adding position horizontally as illustrated in the horizontal position adjustment area 55 on the touch panel 32 in response to a third user operation illustrated by selection of the additional information adjustment key 50 (which may be a different operation from the first user operation, thus being represented differently for the convenience; the same applies to the following). Moreover, the panel control portion 11 preferably controls to display a GUI image for shifting the adding position vertically as illustrated in the vertical position adjustment area 54 on the touch panel 32 in response to a fourth user operation illustrated by selection of the additional information adjustment key 50.

Although the adjusted GUI image will not be illustrated, the panel control portion 11 preferably controls to display a GUI image for changing a text size and/or a text font (that is, a font type) of the additional information as illustrated in the font adjustment area 53 on the touch panel 32 in response to a fifth user operation illustrated by selection of the additional information adjustment key 50.

FIG. 8 is a diagram for explaining an outline that a display color of additional information is adjusted in the digital multi-functional peripheral of FIGS. 2 and 3, which shows an example of a popup image on a GUI image (referred to as a popup image 60) that enables to adjust a display color of additional information. Note that, the popup image 60 is also displayed in a state where position information of sending source information is displayed on image data to be sent that is displayed for previewing same as in FIG. 6B, which will be omitted in FIG. 8.

The popup image 60 illustrated in FIG. 8 is one in which a color adjustment area 59 to allow color selection is provided in the popup image 52 of FIG. 6B. By the color selection in the color adjustment area 59, a change in a text color of sending source information is reflected on additional setting information. In this manner, the panel control portion 11 preferably controls to display a GUI image for changing a color as illustrated in the color adjustment area 59 on the touch panel 32 in response to a sixth user operation illustrated by selection of the additional information adjustment key 50. Note that, it is preferable that touch panel 32 is capable of color display because this makes the adjustment easy.

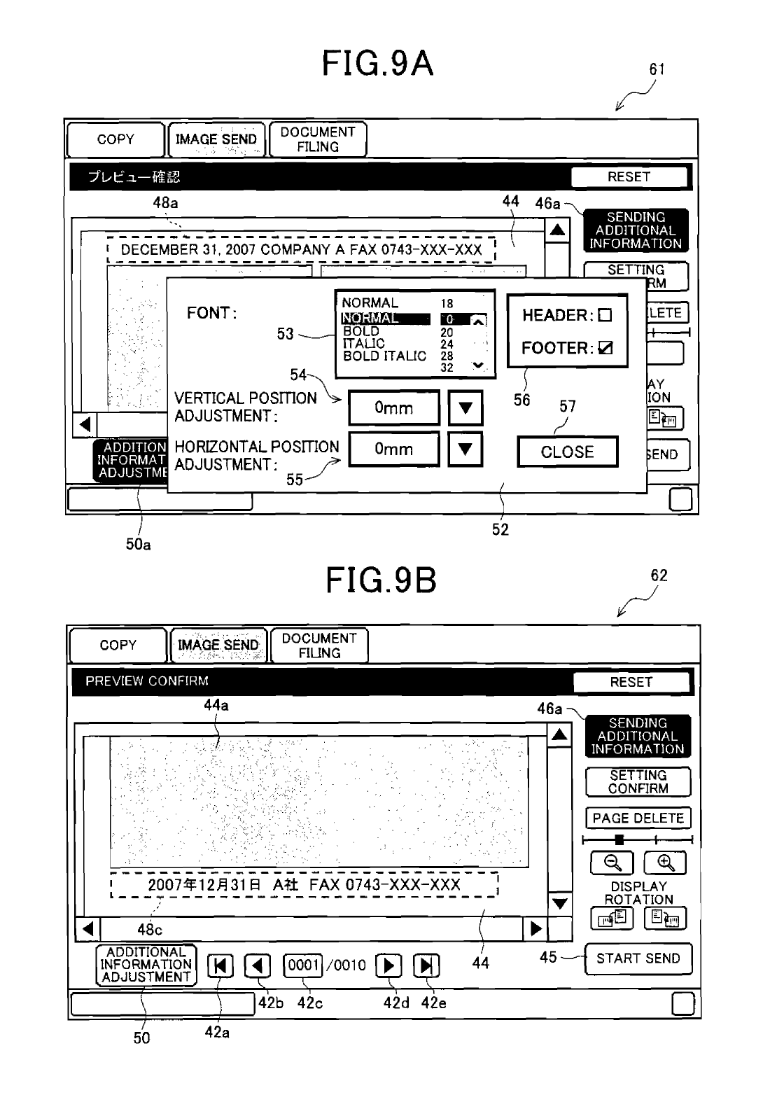

FIGS. 9A and 9B are diagrams for explaining an outline that, while displaying position information of sending source information on image data to be sent that is displayed for previewing, an adding position (display position) thereof is largely adjusted in the digital multi-functional peripheral of FIGS. 2 and 3. FIG. 9A shows a GUI image 61 which is basically the same as the GUI image 51 of FIG. 6B, but is different in terms of selection of the header/footer selection area 56. The header/footer selection area 56 enables to select whether to add additional information to a header of image data or to a footer thereof. An example of change in a position includes a change from the header to the footer or a change from the footer to the header.

More specifically, the GUI image 61 is an image in a state where the footer is selected in the header/footer selection area 56 and vertical and horizontal positions are set to 0 mm, respectively, and the GUI image 51 is an image in a state where the header is selected. After such selection and adjustment, by pressing a selection area of the close key 57, the additional setting information is updated. At the same time, the display of the preview image 44 in the GUI image 61 is changed from only on the upper side to only on the lower side (referred to as a preview image 44a) like the GUI image 62 of FIG. 9B, and a position of the sending source information 48c is also changed to a position defined by the footer.

In this manner, the panel control portion 11 preferably controls to display a GUI image for selecting whether the adding position is at the header position or the footer position as illustrated in the header/footer selection area 56 on the touch panel 32 in response to a second user operation illustrated by selection of the additional information adjustment key 50.

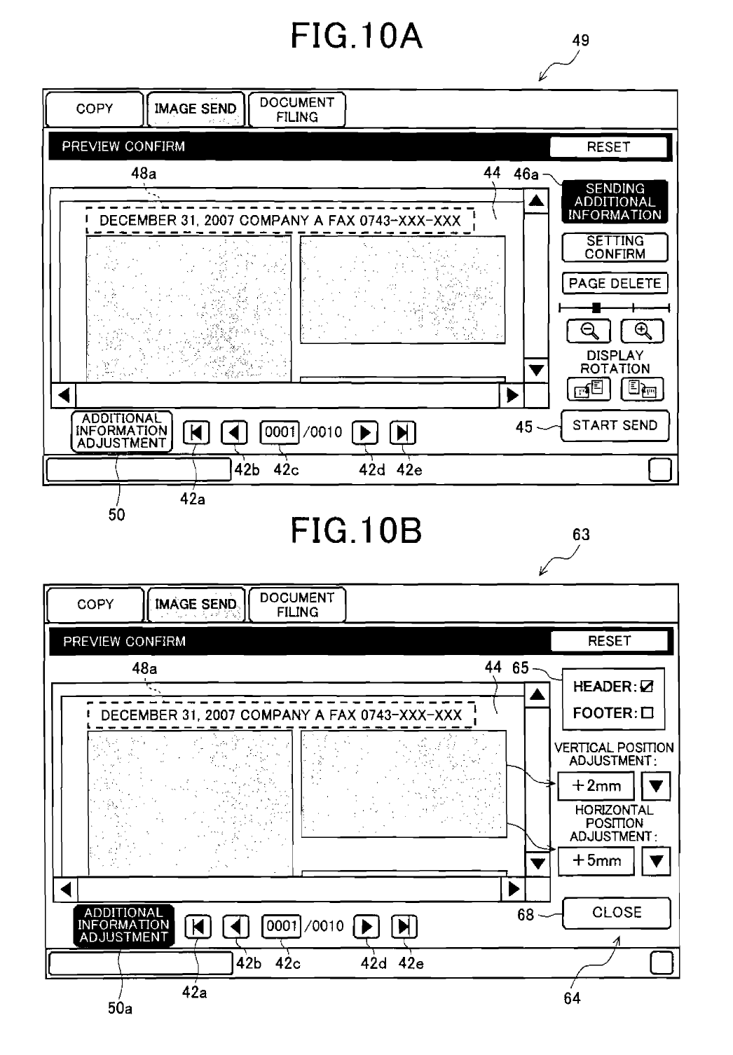

FIGS. 10A and 10B are diagrams for explaining an outline that, while visually identifying image data to be sent that is displayed for previewing and position information of sending source information in a possibly larger area, an adding position thereof is adjusted in the digital multi-functional peripheral of FIGS. 2 and 3. FIG. 10A and the FIG. 6A are the same.

When a selection area of the additional information adjustment key 50 is pressed in the GUI image 49, not a popup image that is overwritten on an area where the preview image 44 is displayed but a setting image 64 is overwritten and displayed on a pressing area of other particularly unrelated setting keys as shown in FIG. 10B. Illustrated as the setting image 64 includes the header/footer selection area 65, the vertical position adjustment area 66, the horizontal position adjustment area 67, and the close key 68. By displaying an image for changing additional information so as not to be overlaid on a preview image and position information as much as possible in this manner, the user easily performs changing.

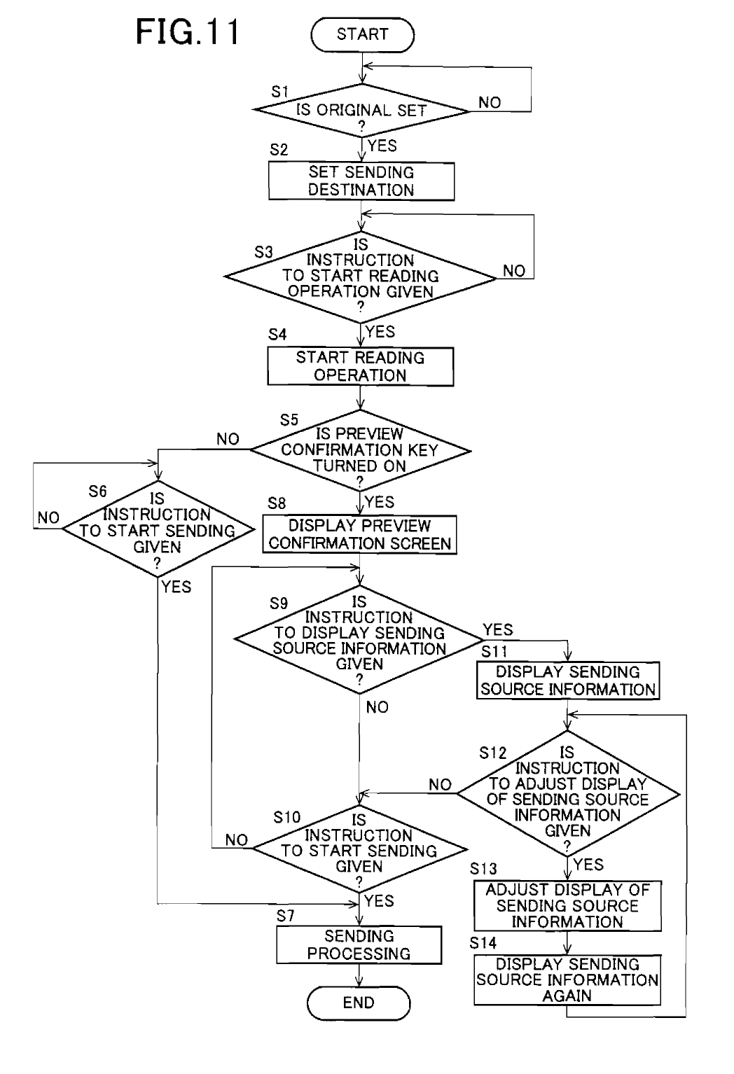

Next, description will be given for the flow of a preview display in sending image data with reference to FIG. 11. FIG. 11 is a flowchart for explaining an example of processing when displaying a preview in sending image data in the digital multi-functional peripheral of FIGS. 2 and 3.

First, the main control portion 18 confirms whether an original is set on a document platen or a document feeder in the reading portion 13 (step S1), and when the original is set (in the case of YES at step S1), a user operation of various settings such as a sending destination is received to reflect the setting (step S2). Then, the main control portion 18 waits for an instruction to start a reading operation (step S3), and when the instruction is received, original reading is instructed to the reading portion 13 (step S4). Thereby, the reading portion 13 starts the original reading.

Subsequently, the main control portion 18 instructs the panel control portion 11 to display the GUI image 41 of FIG. 4A on the touch panel 32 and determines whether or not the preview confirm key 42 is pressed (step S5). In the case of NO at step S5, the main control portion 18 waits for an instruction to start sending by the start key 31d (step S6), and when the instruction is given, the main control portion 18 waits for completion of the original reading and controls each portion to perform sending processing with sending source information added to image data thereof (step S7).

Alternatively, in the case of YES at step S5, the main control portion 18 instructs the preview image generating portion 16a and the panel control portion 11 to switch automatically to the preview screen like the GUI image 43 of FIG. 4B, for example, and display the preview image 44 (step S8). In this case, simultaneously with the original reading, a dialogue message such as “Original is being read.” may be displayed to shift to the preview confirmation screen when image processing for a first sheet of the read original is completed. Also in the middle of the original reading, shifting to the preview confirmation screen may be performed at the time when the preview image is generated or after all originals are read.

Subsequent to step S8, the main control portion 18 determines whether or not the sending additional information key 46 is pressed (step S9), and when not being pressed, presence or absence of a sending start instruction is determined (step S10), and the procedure proceeds to step S7 at the time when the instruction is given and sending processing is performed. If it is determined that there is no instruction at step S10, the procedure returns to step S9.

Alternatively, in the case of YES at step S9, the main control portion 18 instructs the preview image generating portion 16a and the panel control portion 11 to display the sending source information 48a on the preview image 44 like the GUI image 49 of FIG. 6A (step S11) and determines whether a selection area of the additional information adjustment key 50 is pressed (step S12). In association with steps S9 and S11, even when only confirmation of a state where the sending source information is added to image data to be sent is performed and adjustment is not intended to be performed, pressing the sending additional information key 46 makes it possible to add the sending source information to a preview image and to confirm the adding state.

When no pressing is performed at step S12, the procedure proceeds to step S10, and when pressing is performed, the popup image 52 is displayed like in the GUI image 51 of FIG. 6B to receive an adjustment operation and reflect the adjustment (step S13), and the sending source information is displayed again at the same time (step S14) and the procedure returns to step S12.

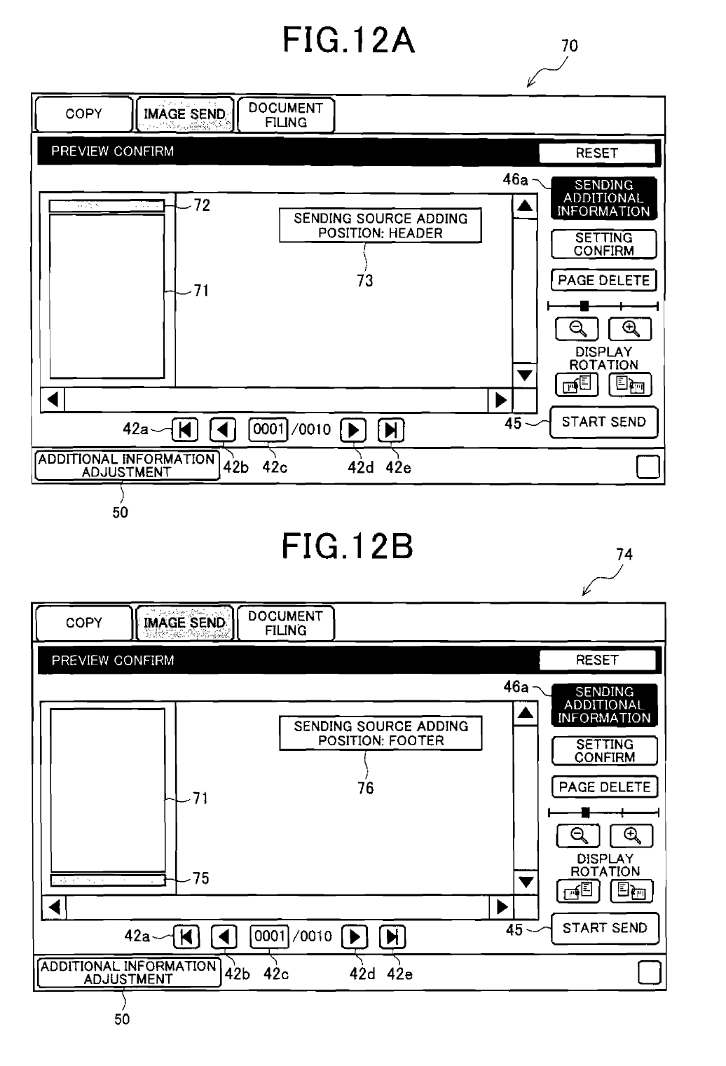

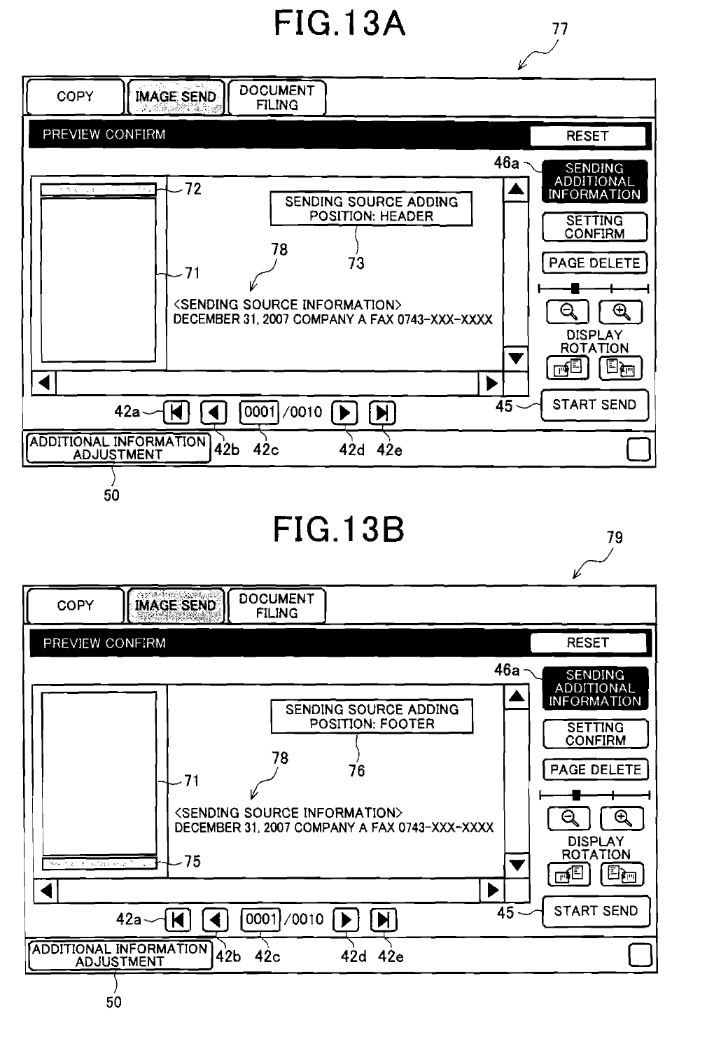

Next, description will be given for another example in which position information of sending source information is displayed with reference to FIGS. 12A to 13B. FIGS. 12A and 12B are diagrams for explaining another example in which position information of sending source information is displayed on image data to be sent that is displayed for previewing in the digital multi-functional peripheral of FIGS. 2 and 3.

FIG. 12A shows another example of GUI image shifted from the GUI image 41 or the GUI image 43 and displayed on the touch panel 32 (referred to as a GUI image 70) when a user presses and selects a selection area of the sending additional information key 46 of FIG. 4B. As illustrated in the GUI image 70, a preview image 71 in which image data to be sent that is included in a facsimile sending job is reduced is generated by the preview image generating portion 16a to be displayed. Moreover, a preview confirmation screen shown by the GUI image 70 may be displayed prior to sending by pressing the preview confirm key 42 to turn on in the GUI image 41 and then pressing a start key 31d.

In the GUI image 70, the send start key 45, the reversed sending additional information key 46a, the additional information adjustment key 50, the page shift keys 42a, 42b, 42d and 42e, the information showing a current page 42c, and the like are displayed, similarly to the GUI image 49 of FIG. 6A and the like.

Further, in the GUI image 70, a display area 72 of sending source information is displayed as information showing a position of the sending source information in a state of being overlaid on the preview image 71 that displays a preview of the entire image data. As described above, GUI image 70 is displayed mainly by the preview image generating portion 16a and the panel control portion 11. Note that, even when a preview image is changed due to horizontal and vertical shift, enlargement/reduction or the like, the display area 72 is displayed at a position corresponding to the changed preview image. The display area 72 is also displayed in a preview image of a page displayed by each of page shift keys 42a, 42b, 42d, and 42e as long as it is set such that sending source information is displayed in that page. A GUI image 74 of FIG. 12B illustrates a GUI image when sending source information is attached to a footer area, where a display area 75 is displayed below the preview image 71.

In this manner, the preview image generating portion 16a and the panel control portion 11 preferably display information showing an adding portion on the touch panel 32 in a state where a preview of the entire image data is displayed on the touch panel 32. That is, in displaying the adding state of the header and the footer, display is preferably performed so that the entire position relation for the image data is recognized. Since the preview image 71 shows the entire image data to be sent and the display area 72 shows a relative position to the preview image 71, it is easy to determine a position to add additional information and it is possible for a user to easily determine whether or not sending may be performed directly. If it is determined that sending may be performed, a selection area of the send start key 45 may be pressed.

Moreover, in the GUI image 70, text information 73 that represents an adding position with texts, such as “sending source adding position: header”, is also displayed on a margin area thereof. Similarly, in the GUI image 74, text information 76 that represents an adding position with texts, such as “sending source adding position: footer”, is also displayed on a margin area thereof. Such a display makes it easier to determine a position to add additional information. In particular, since the preview image 71 displays the entire image data to be sent, it is sometimes difficult for a user who has never used a preview display function in the digital multi-functional peripheral 1 to find what the display area 72 that is synthesized at an upper part thereof shows, but it is possible to understand that the display area 72 is the header area by displaying such text information 73.

However, it is preferable that additional information to be actually added is also displayed to enable to confirm the additional information, and an example of which serving as the GUI image 70 will be described with reference to FIGS. 13A and 13B. FIG. 13A and 13B are diagrams for explaining another example in which position information of sending source information is displayed on image data to be sent that is displayed for previewing in the digital multi-functional peripheral of FIGS. 2 and 3.

A GUI image 77 of FIG. 13A and a GUI image 79 of FIG. 13B are examples of images displayed instead of the GUI image 70 and the GUI image 74. In the GUI image 77 and the GUI image 79, actual sending source information 78 is displayed at a position different from an adding position. In this manner, the preview image generating portion 16a and the panel control portion 11 preferably display additional information (contents of additional information) in a display area different from a display area of information showing the adding position. Note that, in the GUI image 70 and the GUI image 74, a key image for displaying the actual additional information (sending source information in this example) separately may be included so that the GUI image 77 and the GUI image 79 are displayed by selection of the key image. Moreover, a key image for changing contents of the additional information may be included in the GUI image 77 and the GUI image 79 to make it possible to change the additional information itself. Although the example in which the header 72 and the footer 75 are added and displayed out of the area of the preview image 71 has been shown in FIGS. 12A to 13B, the header 72 and the footer 75 may be displayed in a state of being overlaid on the preview image 71.

According to the present invention, it is possible to prevent that, at the time of sending image data with additional information such as sending source information added thereto, an adding position of the additional information is erroneously set and that the additional information is overlaid on a part other than a margin of the image data.

1. An image sending apparatus that includes an image display portion for displaying a preview of image data and that is capable of sending the image data with additional information added thereto, wherein
a display control portion for displaying information showing an adding position at which the additional information is added to the image data subjected to a preview display by the image display portion on the image display portion in the preview display is included.

2. The image sending apparatus as defined in claim 1, wherein
the display control portion displays the information showing the adding position on the image display portion in a state where a preview of a whole of the image data is displayed on the image display portion.

3. The image sending apparatus as defined in claim 2, wherein
the display control portion displays the additional information in a display area different from a display area of the information showing the adding position.

4. The image sending apparatus as defined in claim 1, wherein the display control portion displays the additional information at the adding position as the information showing the adding position.

5. The image sending apparatus as defined in claim 1, wherein
the additional information includes any one of or a plurality of information of a name of a sender, information of a telephone number of a sending source, information of an electronic mail address of a sending source, and information of date and time in sending.

6. The image sending apparatus as defined in claim 1, wherein
the display control portion displays a predetermined graphical user interface image for changing the adding position on the image display portion in response to a user operation, and
the predetermined graphical user interface image includes any one of or a plurality of an image for selecting whether the adding position is at a header position or at a footer position, an image for shifting the adding position horizontally, an image for shifting the adding position vertically, and an image for changing a text size and/or a text font of the additional information.

7. The image sending apparatus as defined in claim 1, wherein
the image sending apparatus has a function of sending the image data by facsimile and/or a function of sending the image data by internet facsimile.
